(19) United States
(12) Patent Application Publication
(10) Pub. No.: US 2016/0119455 A1
(43) Pub. Date: Apr. 28, 2016

(54) WIRELESS DEVICE, METHOD, AND COMPUTER READABLE MEDIA FOR FRAGMENTATION AND AGGREGATION WITH BLOCK ACKNOWLEDGEMENT IN A WIRELESS LOCAL-AREA NETWORK

(71) Applicant: Robert J. Stacey, Portland, OR (US)

(72) Inventor: Robert J. Stacey, Portland, OR (US)

(21) Appl. No.: 14/524,902

(22) Filed: Oct. 27, 2014

(51) Int. Cl. H04L 29/08; H04W 28/06; H04W 72/04; H04L 5/00

(52) U.S. Cl. CPC H04L 69/324; H04L 5/0055; H04W 28/065; H04W 72/0446; H04W 84/12

(57) ABSTRACT

Wireless devices, methods, and computer readable media for fragmentation and aggregation with block acknowledgement in a wireless local-area network. A wireless communication device for fragmentation may include circuitry configured to fragment a media access control (MAC) service data unit (MSDU) into a plurality of MAC protocol data units (MPDU). The circuitry may be configured to set a sequence number field of each of the MPDUs of the plurality of MPDUs, where the sequence number indicates the relative position of the MPDU in a transmission stream of MPDUs, and set a position indication field of each of the MPDUs of the plurality of MPDUs to indicate a position of each MPDU in the plurality of MPDUs. The position indication field may indicate whether each MPDU is a start, a middle, or a last MPDU. The circuitry may be configured to aggregate MSDUs and fragments of MSDUs.

### TECHNICAL FIELD

Embodiments pertain to wireless communications in a wireless local-area network (WLAN). Some embodiments relate to fragmentation of media access control (MAC) service data unit (MSDU) and aggregation of fragments of MSDUs and MSDUs. Some embodiments relate to fragmentation and aggregation for allocations during a shared transmission opportunity. Some embodiments relate to fragmentation that supports using a compressed block acknowledgement.

### BACKGROUND

One issue with communicating data over a wireless network is transmitting and receiving MSDUs and acknowledging received packets. Efficiently transmitting and receiving MSDU may enable more efficient use of the wireless medium and may affect how well stations (STA) operate.

Thus there are general needs for systems and methods for efficiently transmitting and receiving MSDU and acknowledging received packets.

### BRIEF DESCRIPTION OF THE DRAWINGS

FIG. 1 illustrates a wireless network in accordance with some embodiments;

FIG. 2 illustrates the operation of a method for fragmentation according to example embodiments;

FIG. 3 illustrates the operation of a method for fragmentation and aggregation according to example embodiments;

FIG. 4 illustrates the operation of a method for fragmentation and aggregation according to example embodiments;

FIG. 5 illustrates the operation of a method for fragmentation and aggregation according to example embodiments;

FIG. 6 illustrates a method of fragmenting and aggregating MSDUs according to example embodiments;

FIG. 7 illustrates a block acknowledgement according to example embodiments;

FIG. 8 illustrates a method of reconstructing fragmented and aggregated MPDUs according to example embodiments;

FIG. 9 illustrates a MPDU according to example embodiments. MPDU 900 is an existing frame format that may be modified to accommodate the position indication field; and

FIG. 10 illustrates a high-efficiency wireless (HEW) device in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

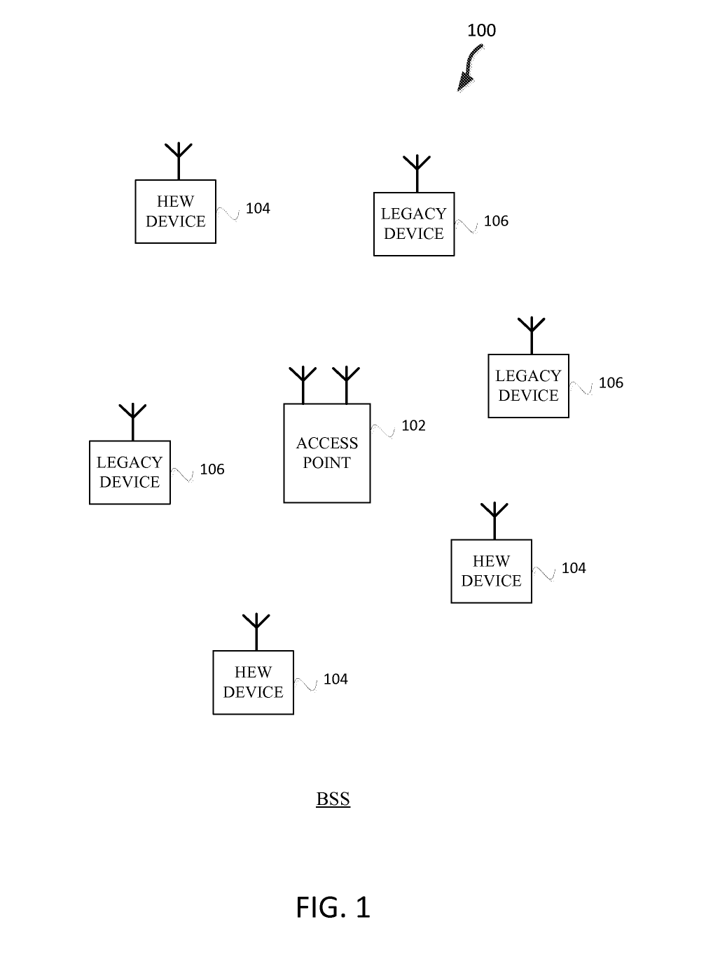

FIG. 1 illustrates a wireless network in accordance with some embodiments. The wireless local-area network (WLAN) may comprise a basis service set (BSS) 100 that may include an access point (AP) 102, a plurality of high-efficiency wireless (HEW). For example, Institute for Electronic and Electrical Engineers (IEEE) 802.11ax devices 104 and a plurality of legacy (e.g., IEEE 802.11n/ac) devices 106.

The AP 102 may be an access point (AP) using the 802.11 to transmit and receive. The AP 102 may be a base station. The AP 102 may use other communications protocols as well as the 802.11 protocol. The 802.11 protocol may be 802.11ax. The 802.11 protocol may include using Orthogonal Frequency-Division Multiple Access (OFDMA), time division multiple access (TDMA), and/or code division multiple access (CDMA). The 802.11 may include a multiple access technique may be a space-division multiple access (SDMA) technique such as multi-user (MU) multiple-input and multiple-output (MIMO)(MU-MIMO).

The HEW devices 104 may operate in accordance with 802.11ax or another standard of 802.11. The legacy devices 106 may operate in accordance in accordance with one or more of 802.11 a/b/g//n/ac, or another legacy wireless communication standard.

The HEW devices 104 may be wireless transmit and receive devices such as cellular telephone, handheld wireless device, wireless glasses, wireless watch, wireless personal device, tablet, or another device that may be transmitting and receiving using the 802.11 protocol such as 802.11ax or another wireless protocol.

The BSS 100 may operate on a primary channel and zero or more secondary channels or sub-channels. The BSS 100 may include one or more APs 102. In accordance with embodiments, the AP 102 may communicate with one or more of the HEW devices 104 on one or more of the secondary channels or sub-channels or the primary channel. In example embodiments, the AP 102 communicates with the legacy devices 106 on the primary channel. In example embodiments, the AP 102 may be configured to communicate concurrently with one or more of the HEW devices 104 on one or more of the secondary channels and a legacy device 106 utilizing only the primary channel and not utilizing any of the secondary channels.

The AP 102 may communicate with legacy devices 106 in accordance with legacy IEEE 802.11 communication techniques. In example embodiments, the AP 102 may also be configured to communicate with HEW devices 104 in accordance with legacy IEEE 802.11 communication techniques. Legacy IEEE 802.11 communication techniques may refer to any IEEE 802.11 communication technique prior to IEEE 802.11ax.

In some embodiments, a HEW frame may be configurable to have the same bandwidth and the bandwidth may be one of 20 MHz, 40 MHz, or 80 MHz, 160 MHz, 320 MHz contiguous bandwidths or an 80+80 MHz (160 MHz) non-contiguous bandwidth. In some embodiments, bandwidths of 1 MHz, 1.25 MHz, 2.5 MHz, 5 MHz and 10 MHz or a combination thereof may also be used. A HEW frame may be configured for transmitting a number of spatial streams.

In other embodiments, the AP 102, HEW device 104, and/or legacy device 106 may also implement different technologies such as CDMA2000, CDMA2000 1×, CDMA2000 EV-DO, Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

In an OFDMA system (e.g. 802.11ax), an associated HEW device 104 may operate on a subchannel, which may be 20 MHz, of the BSS 100 (that can operate for example at 80 MHz). The HEW device 104 may enter a power save and upon coming out of power save mode, the HEW device 104 may need to re-synchronize with BSS 100 by receiving a beacon. If a beacon is transmitted only on the primary channel, then HEW device 104 needs to move and tune to the primary channel upon waking up to be able to receive beacons. Then the HEW device 104 needs to re-tune back to its operating subchannels, which may be 20 MHz, or it has to follow a handshake procedure to let AP 102 know of a new operating subchannel. The HEW device 104 may risk losing some frames during the channel switch, in example embodiments.

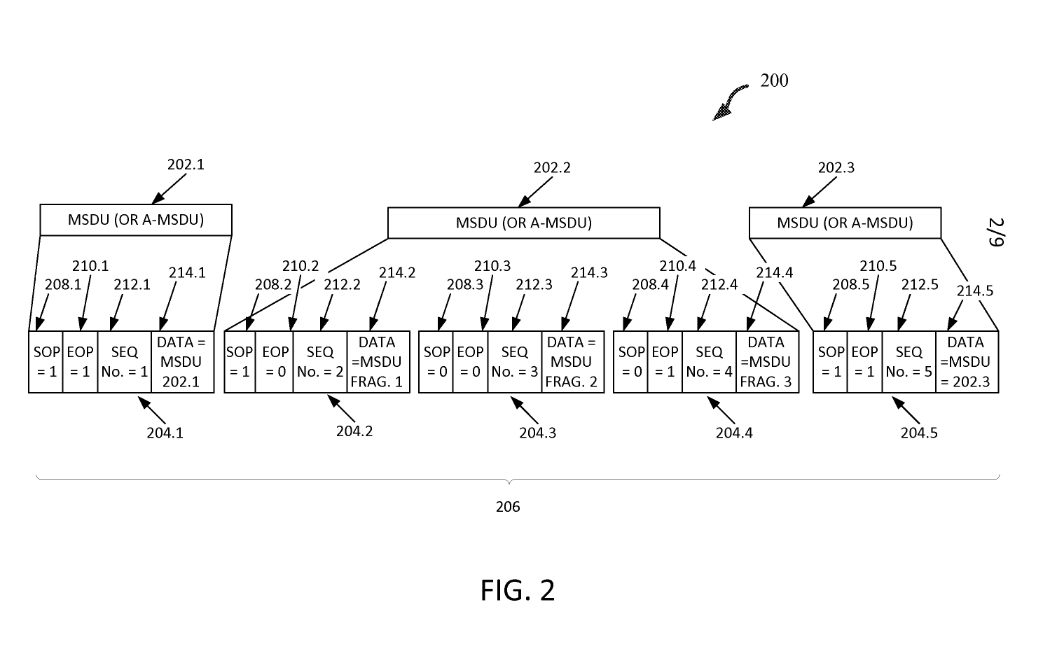

In example embodiments, the HEW device 104 is configured to fragment MSDUs, aggregate MSDUs and/or MPDUs, and/or use beacon frames according to one or more of the embodiments disclosed herein in conjunction with FIGS. 2-0.

Some embodiments relate to high-efficiency wireless communications including high-efficiency WLAN and high-efficiency wireless (HEW) communications. In accordance with some IEEE 802.11ax (High-Efficiency WLAN (HEW)) embodiments, an AP 102 may operate as a master station which may be arranged to contend for a wireless medium (e.g., during a contention period) to receive exclusive control of the medium for an HEW control period (i.e., a transmission opportunity (TXOP)). The AP 102 may transmit an HEW master-sync transmission at the beginning of the HEW control period. During the HEW control period, HEW devices 104 may communicate with the AP 102 in accordance with a non-contention based multiple access technique. This is unlike conventional WLAN communications in which devices communicate in accordance with a contention-based communication technique, rather than a multiple access technique. During the HEW control period, the AP 102 may communicate with HEW devices 104 using one or more HEW frames. During the HEW control period, legacy stations refrain from communicating. In some embodiments, the master-sync transmission may be referred to as an HEW control and schedule transmission.

In some embodiments, the multiple-access technique used during the HEW control period may be a scheduled orthogonal frequency division multiple access (OFDMA) technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique.

The master station may also communicate with legacy stations in accordance with legacy IEEE 802.11 communication techniques. In some embodiments, the master station may also be configurable communicate with HEW devices 104 outside the HEW control period in accordance with legacy IEEE 802.11 communication techniques, although this is not a requirement.

FIG. 2 illustrates the operation of a method for fragmentation according to example embodiments. Illustrated in FIG. 2 are media access control (MAC) service data units (MSDUs) 202, MAC protocol data units (MPDUs) 204, and a stream 206 of MPDUs 204 to send to the PHY layer 704.

The MSDUs 202 may be data that was received by the MAC layer 1006 to deliver to another MAC layer (not illustrated) on the network, which may be the BSS 100. The MSDU 202 may comprise higher level data that is not part of the control information associated with communication.

The MPDUs 204 may be packets that are sent to the PHY 1004 to send over a wireless medium. The PHY 704 layer may encapsulate the MPDUs 204 in other packets. The MPDUs 204 may comprise a sequence number (SEQ No.) 212 that indicates a sequence number for the MPDU 204 in a stream 206 of MPDU 204 that are to be sent across the wireless medium to another HEW device 102. The MPDU 204 may include data 214 which is the payload of the MPDU 204 and may be the data in the MSDU 202.

The MPDUs 204 may comprise a position indication field that indicates the position of the MPDU 204 within a fragmentation of a MSDU 202. In some embodiments, the position indication field may be represented with a start of packet (SOP) field 208 and end of packet (EOP) field 210, which may be fields to indicate whether the MPDU is fragmented and, if so, the position of the MPDU 204 within the fragmentation. Table 1 illustrates a possible encoding of a fragmentation position indication field, according to some embodiments.

TABLE 1
A FRAGMENTATION POSITION INDICATION FIELD

| Start of Packet | End of Packet | |
|---|---|---|
| (SOP) | (EOP) | Meaning |
| 0 | 0 | A MPDU that is a middle packet |
| | | of the fragmentation of a MSDU. |
| 0 | 1 | A MPDU that is the end or last |
| | | packet of a fragmentation of a |
| | | MSDU. |
| 1 | 0 | A MPDU that is the start or first |
| | | packet of a fragmentation of a |
| | | MSDU. |
| 1 | 1 | A packet that contains a MSDU |
| | | that is not fragmented |

The MAC layer 1006 may take the MSDUs 202 and determine whether or not to fragment the MSDUs 202. The MAC layer 1006 may determine whether to fragment the MSDUs 202 based on a time the HEW device 104 has to transmit during a contention free transmit opportunity, which may have been received from the AP 102 and may be called a TXOP. The MAC layer 1006 may determine whether to fragment the MSDUs 202 based on a size of the MSDU 202. The MAC layer 1006 may try to fill the time that the MAC layer 1006 has to transmit by fragmenting a MSDU 202, and aggregating the fragmented MSDU 202 with another MSDU 202.

As illustrated, the MAC layer 1006 does not fragment the first MSDU 202.1. The MAC layer 1006 generates the MPDU 204.1 and sets the SOP 208.1 equal to 1, the EOP 210.1 equal to 1, SEQ No. 212.1 equal to 1, and the data 214.1 equal to MSDU 202.1. Referring to Table 1, the meaning of SOP equal to 1, and EOP equal to 1 is that the MSDU 202.1 was not fragmented.

The MAC layer 1006 may determine to fragment MSDU 202.2 because MSDU 202.2 may be too large to send at once due to a transmission time limitation, or to aggregate a fragment of MSDU 202.2 with another MSDU 202 to fill a MPDU 204. The MAC layer 1006 fragments MSDU 202.2 into three MPDUs 204.2, 204.3, and 204.4. The MAC layer 1006 sets MPDU 204.2 with SOP 208.2 equal to 1 and EOP 210.2 equal to 0, which has the meaning according to Table 1 of being the first MPDU 204 in a fragmentation. The MAC layer 1006 sets the sequence number 204.2 to 2 because it is the second MPDU 204 in the stream 206. The data 214.2 is set to fragment 1 of the MSDU 202.2.

For the next MPDU 204.3, the MAC layer 1006 sets SOP 208.3 equal to 0 and EOP 210.3 equal to 0, which has the meaning according to Table 1 of being a middle packet in a fragmentation of a MSDU 202. The MAC layer 1006 sets the sequence number to 3 because it is the third MPDU 204 in the stream 206. The MAC layer 1006 sets the data 214.3 to fragment 2 of the MSDU 202.2.

For the next MPDU 204.4, the MAC layer 1006 sets SOP 208.4 equal to 0 and EOP 210.4 equal to 1, which has the meaning according to Table 1 of being a last packet of a MPDU 204 fragmentation. The MAC layer 706 sets the sequence number to 4 because it is the fourth MPDU 204 in the stream 206. The data 214.4 is set to fragment 3 of the MSDU 202.2.

The MAC layer 1006 then determines not to fragment MSDU 202.3. The MAC layer 1006 sets MPDU 204.5 with SOP 208.5 equal to 1 and EOP 210.5 equal to 1, which has the meaning according to Table 1 of being a MPDU 204 that contains a MSDU 202 that is not fragmented. The MAC layer 1006 sets the sequence number 212.5 to 5 because it is the fifth MPDU 204 in the stream 206. The data 214.5 is set to MSDU 202.3. The MAC layer 1006 may then send the MPDUs 204 to the PHY layer 1004 to transmit to another HEW device 104. The receiver of the fragmented MSDU 202 may reconstruct the MSDU 202 from the fragments by using the sequence numbers 212, SOPs 208, and EOPs 210.

In example embodiments, another layer such as the PHY layer 1004 may set one or more of the MPDU 204 fields. In example embodiments, the size of the stream 206 is based on a time the HEW device 104 has to transmit during an allocation which may be a contention free transmit opportunity, which may have been received from the AP 102 and may be called a TXOP.

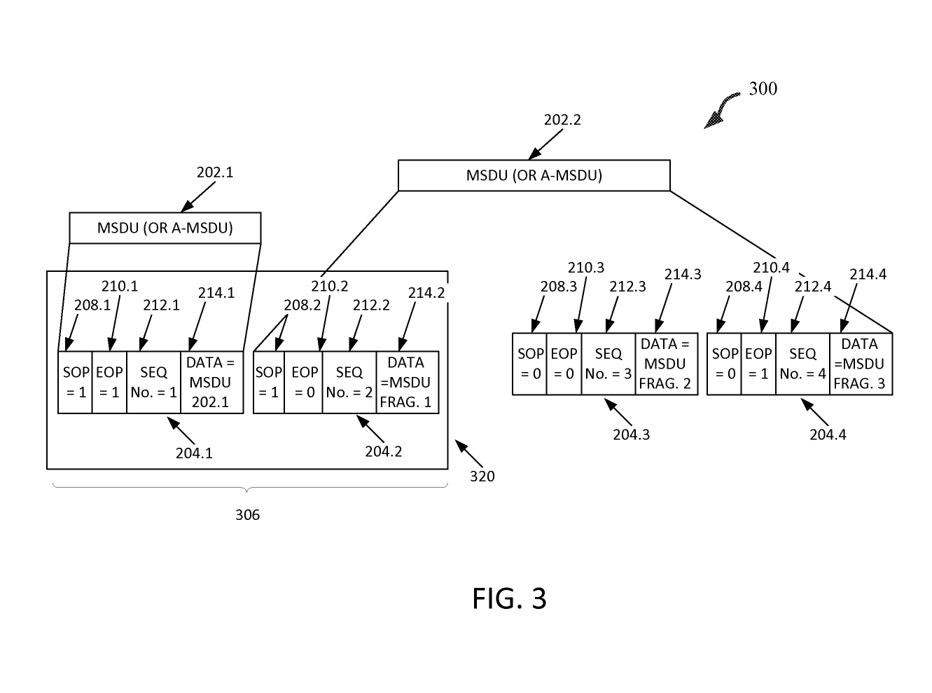

FIG. 3 illustrates the operation 300 of a method for fragmentation and aggregation according to example embodiments. Illustrated in FIG. 3 are MSDUs 202, MPDUs 204, an aggregated MPDU 320, and a stream 306 of MPDUs 204 to send to the PHY layer 1004.

The MAC layer 1006 may have received MSDU 202.1 and MSDU 202.2. The MAC layer 1006 may determine to fragment MSDU 202.2 into MPDU 204.2, 204.3, and 204.4. The MAC layer 1006 may have determined to fragment MSDU 202.2 based on there being room available in the aggregated MPDU 320 for the stream 306. The size of the stream 306 may be based on an allocation of an allocation from the AP 102.

The MAC layer 1006 may aggregate MPDU 204.1 and MPDU 204.2 together in an aggregated MPDU 320. The aggregated MPDU 320 may then be transmitted by the PHY layer 1004 during a TXOP and the other fragments of MSDU 202, which are MPDU 204.3 and MPDU 204.4, may be transmitted in a subsequent TXOP. The receiver of the fragmented MSDU 202 may reconstruct the MSDU 202 from the fragments by using the sequence numbers 212, SOPs 208, and EOPs 210.

In example embodiments, MPDU 204.1 and MPDU 204.2 are sent to the PHY layer 1004 without being placed in an aggregated MPDU 320. The fragmenting of the MSDU 202 may be based on a size of the stream 306.

Example embodiments have the advantage that by fragmenting a MSDU and then aggregating a portion of the fragmented MSDU with another MSDU that an allocation, which may be a TXOP, may be used more fully.

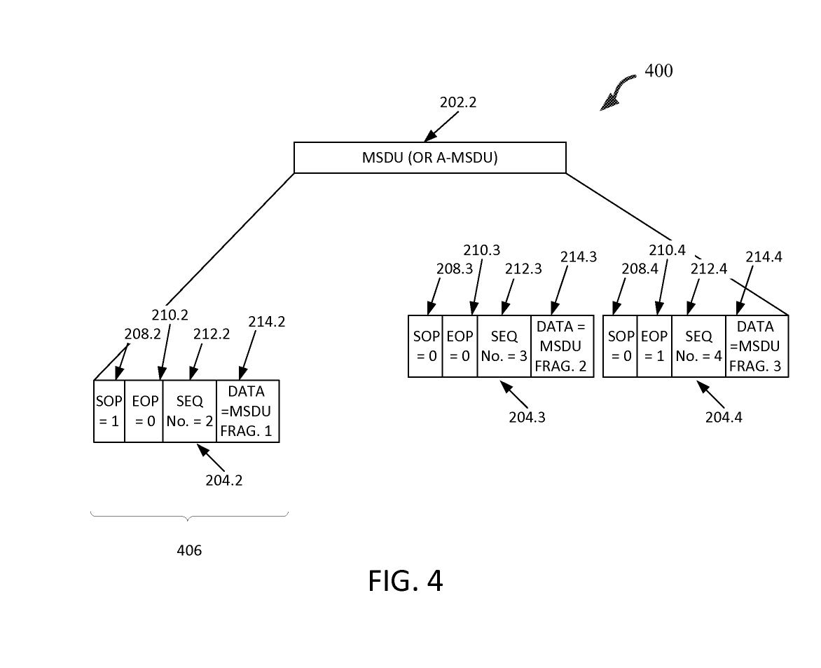

FIG. 4 illustrates the operation 400 of a method for fragmentation and aggregation according to example embodiments. Illustrated in FIG. 4 are MSDU 202.2, MPDUs 204, and a stream 406 of a MPDU 204.2 to send to the PHY layer 1004.

The MAC layer 1006 may have received MSDU 202.2. The MAC layer 1006 may determine to fragment MSDU 202.2 into MPDU 204.2, 204.3, and 204.4. The MAC layer 1006 may have determined to fragment MSDU 202.2 based on their not being enough time available in the stream 406, which may be an allocation of an a TXOP, to transmit the entire MSDU 202.2.

The MAC layer 1004 may then send MPDU 204.2 to be transmitted by the PHY layer 1004 during a TXOP. The other fragments of MSDU 202, which are MPDU 204.3 and MPDU 204.4, may be transmitted in a subsequent allocation, which may be a TXOP, or, in example embodiments, may be during a time when the HEW device 104 contended for the wireless medium. The receiver of the fragmented MSDU 202 may reconstruct the MSDU 202 from the fragments by using the sequence numbers 212, SOPs 208, and EOPs 210.

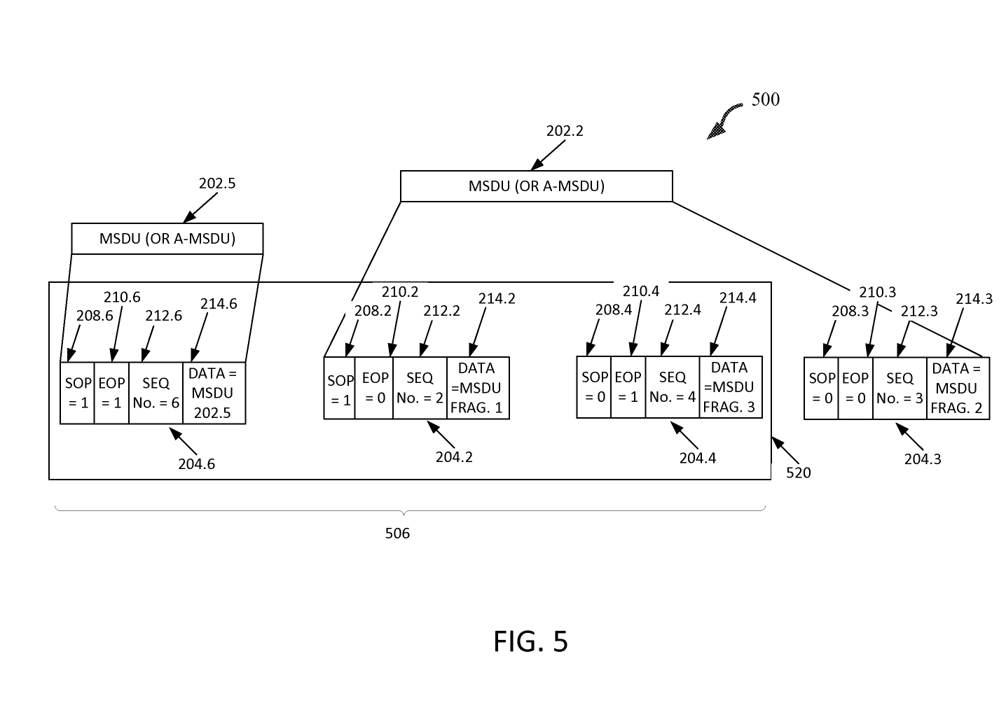

FIG. 5 illustrates the operation 500 of a method for fragmentation and aggregation according to example embodiments. Illustrated in FIG. 5 are MSDUs 202, MPDUs 204, an aggregated MPDU 520, and a stream 506 of MPDUs 204 to send to the PHY layer 1004.

The MAC layer 1006 may have received MSDU 202.5 and MSDU 202.2. MPDU 202.2, MPDU 204.3 and MPDU 204.4 may have already been sent to the PHY layer 1004 for transmission and a block acknowledgement (not illustrated) may have been received that indicates that MPDU 204.3 was received, but does not indicate that MPDU 204.2 and MPDU 204.4 were received.

The MAC layer 1006 may determine that MPDU 204.2 and MPDU 204.4 need to be resent. The MAC layer 1006 may determine to aggregate MPDU 204.6, MPDU 204.2, and MPDU 204.4 based on a size of the stream 506. The MAC layer 1006 may have determined to fragment MSDU 202.2 in an earlier transmission. The MAC layer 1006 may include MPDU 204.6, MPDU 204.2, and MPDU 204.4 in an aggregated MPDU 520, or, in example embodiments, the MAC layer 1006 may send each of the MPDUs 204.6, 204.2, and 204.4 to the PHY layer 1004 to be transmitted over the wireless medium. The size of the stream 506 may be based on an allocation of a TXOP.

In example embodiments, there may be more fragments of MSDU 202.2 that need to be retransmitted that are retransmitted in a next allocation. In example embodiments, the MAC layer 1006 may aggregate a subsequent MSDU 202 (not illustrated) with MPDU 202.5, MPDU 204.2, and MPDU 204.4. In example embodiments, the MAC layer 1006 may aggregate fragments from different MSDUs 202. In example embodiments, the sequence numbers 212 are not reset to the new stream 506, but the original sequence numbers are used. For example, for MPDU 204.4, the sequence number 4 remains so that the receiving HEW device 104 may know it has received the MPDU 204.4 with sequence number 4, and so that the receiving HEW 104 may reconstruct the fragmented MSDU 202.

The receiver of the retransmitted fragments MPDU 204.2 and MPDU 204.4 may reconstruct the MSDU 202.2 from the fragments by using the sequence numbers 212, SOPs 208, and EOPs 210.

Example embodiments have the advantage that by aggregating fragments that need to be resent with other fragment MPDUs 204 and/or MPDUs 204 that an allocation, which may be a TXOP, may be used more fully.

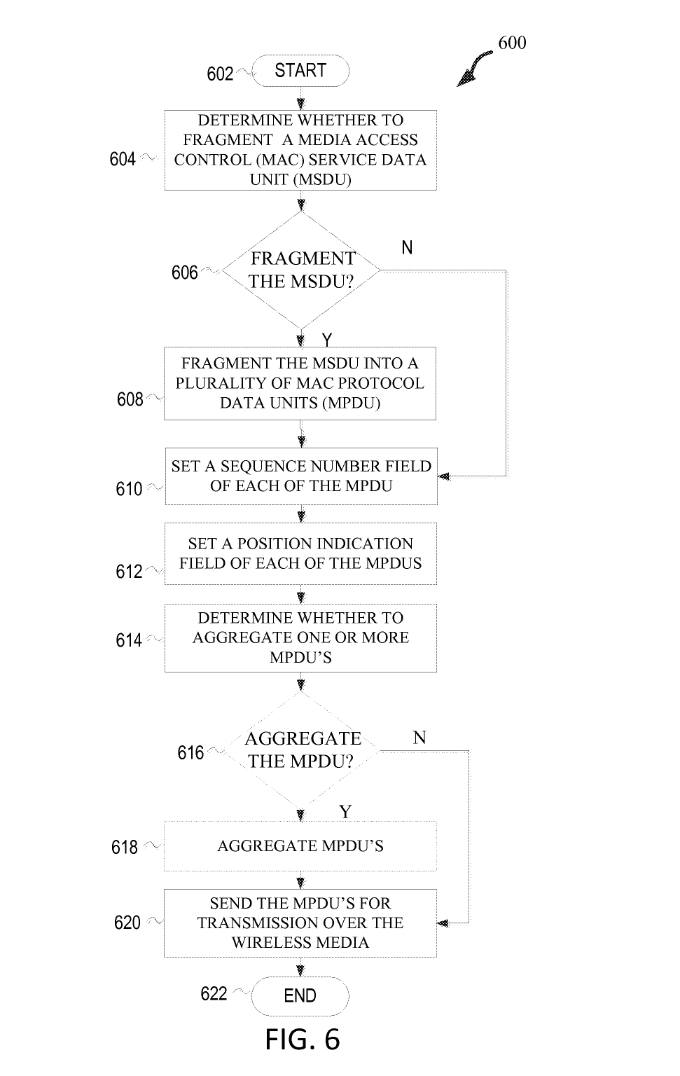

FIG. 6 illustrates a method 600 of fragmenting and aggregating MSDUs according to example embodiments. The method 600 may start at 602 and continue at operation 604 with determining whether or not fragment a MSDU. For example, the MAC layer 1004 may determine to fragment an MSDU if an allocation does not permit enough time to transmit the entire MSDU (see FIG. 4), if the an allocation already includes other MSDUs and there isn't enough room for the entire MSDU (see FIG. 3), or if the MSDU is too large for a MPDU (see FIG. 2).

The method 600 continues at operation 606 with fragment the MSDU. If he MSDU is to be fragmented then the method 600 continues at operation 608 with fragment the MSDU. For example, FIG. 2 illustrates MSDU 202.2 being fragmented into MPDU 204.2, 204.3, 204.4. The method 600 continues at operation 610 with setting a sequence number field of each of the MPDUs. For example, FIG. 2 illustrates the sequence number 212 being set for each of the MPDUs 204.1, 204.2, 204.3, 204.4, and 204.5.

The method 600 continues at operation 612 with setting a position indication field of each of the MPDUs. For example, FIG. 2 illustrates the SOP 208 and EOP 210 fields being set for each of the MPDUs 204.

The method 600, optionally, continues at operation 614 with determining whether to aggregate one or more MPDUs. For example, the MAC layer 706 may determine to aggregate one or more MPDUs because a TXOP is not completely filled previous MPDUs (see FIG. 3), or the MAC layer 1006 may determine to aggregate one or more MPDUs that need to be retransmitted with other MDPUs (see FIG. 5).

The method 600, optionally, continues at operation 616 with aggregate the MPDU. The method 600, optionally, continues at operation 618 with aggregating MPDUs, if it is determine to aggregate MPDUs. For example, FIGS. 3 and 5 illustrate the MAC layer 1006 aggregating MPDUs.

The method 600 continues at operation 620 with sending the MPDU for transmission over the wireless medium. For example, the MAC layer 1006 may send the MPDUs to the PHY layer 1004 for transmission over the wireless medium.

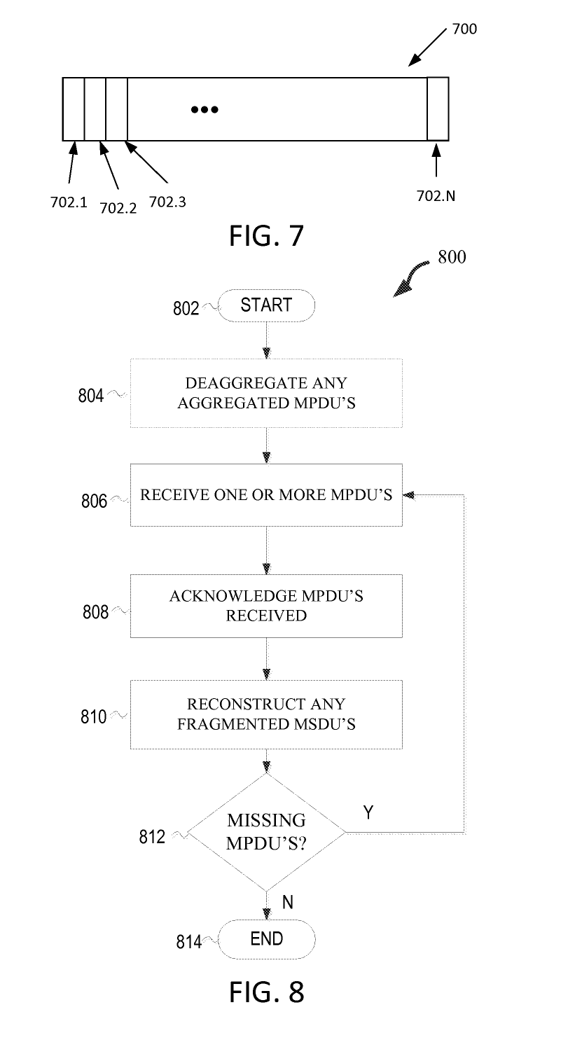

FIG. 7 illustrates a block acknowledgement 700 according to example embodiments. Illustrated in FIG. 7 is a block acknowledgement 700 which may comprise n bits 702.1 through 702.n. Each bit may be used to acknowledge a sequence number that was received by a HEW device 104. In example embodiments, n may be 64 and the block acknowledgement 700 is 8 bytes. A block acknowledgement 700 that uses 1 bit per to acknowledge a sequence number of a MPDU may be termed a compressed block acknowledgment. Some block acknowledgments that are used for fragmentation use a block acknowledgement that has a bit for a MSDU and then a bit for each of the fragments for the MSDU. This type of block acknowledgement is not a compressed block acknowledgement.

FIG. 8 illustrates a method 800 of reconstructing fragmented and aggregated MPDUs according to example embodiments. The method 800 starts at 802 and continues, optionally, at operation 804 with deaggregate any aggregated MPDUs. For example, the HEW device 104 may deaggregate aggregated MPDU 320 (FIG. 3) or aggregated MPDU 520 by using indications in the aggregate MPDUs.

The method 800 continues at operation 806 with receiving one or more MPDUs. For example, a HEW device 104 may receive the MPDUs 204 that would be transmitted in FIGS. 2-5. The method 800 continues at operation 808 with acknowledging MPDUs received. For example, the HEW device 104 may use the block acknowledgement illustrated in FIG. 7 and for each sequence number received set the corresponding bit in the block acknowledgement. For example, referring to FIG. 3, if the HEW device 104 received MPDU 204.1 and MPDU 204.2, then it would set bit 701.1 to 1 and bit 701.2 to 1.

The method 800 may continue at operation 810 reconstruct any fragmented MSDUs. For example, the HEW device 104 may be able to re-construct the MSDU using the sequence numbers 204.2, SOP 208, and EOP 210. For example, referring to FIG. 2, the HEW device 104 may receive MPDU 204.2, MPDU 204.3, and MPDU 204.4. The HEW device 104 can determine that MPDU 204.2 is the first fragment of MSDU 202.2 since SOP 208.2 is equal to 1. The HEW device 104 can determine that the last fragment (or third fragment) is MPDU 204.4 since EOP 210.4 is equal 1. And the HEW device 104 can determine middle fragments since EOP 210.3 is equal to 0 and SOP 208.3 is equal to 0, and because the sequence number 212.3 is 3, which is between the start sequence number 212.2 (2), and the end sequence number 212.4 (4). Moreover, any number of middle fragments can be determined and reconstructed properly using the sequence number 212.

Thus, the use of the sequence number 212 and the position indication field, which here is SOP 208 and EOP 210, enables only one bit per sent MPDU 204 to be sent in the block acknowledgement 700, which provides a more efficient block acknowledgement 700.

The method 800 continues at operation 812 with missing MPDUs. If there are missing MPDUs, then the method 800 may return to operation 804 with deaggregating any aggregated MPDUs. The method 800 may end once all the MPDUs are received.

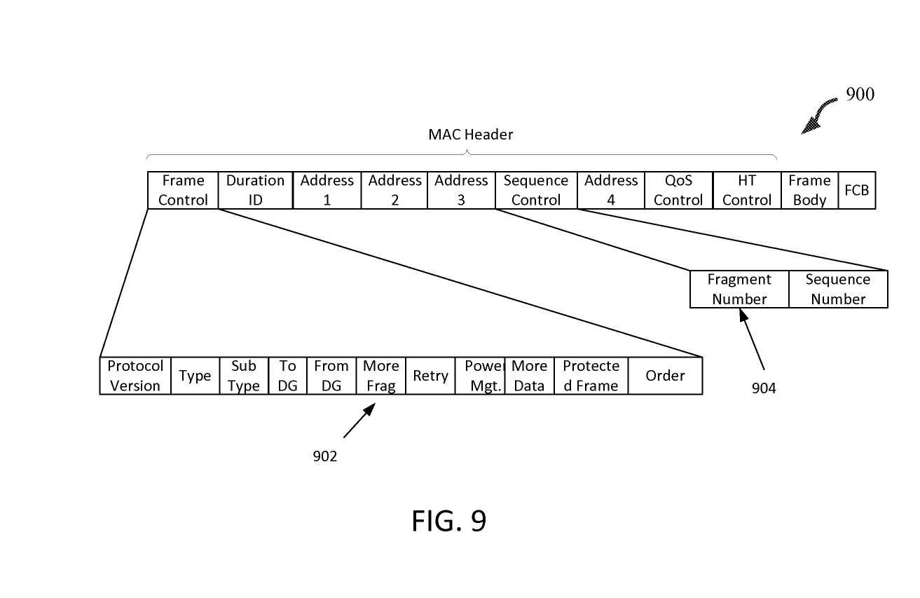

FIG. 9 illustrates a MPDU according to example embodiments. MPDU 900 is an existing frame format that may be modified to accommodate the position indication field. For example, the “more frag” 902 field could be used as the EOP 210 bit and the fragment number 904 may be used as the SOP 208. Other possibilities are readily recognizable by one skilled in the art.

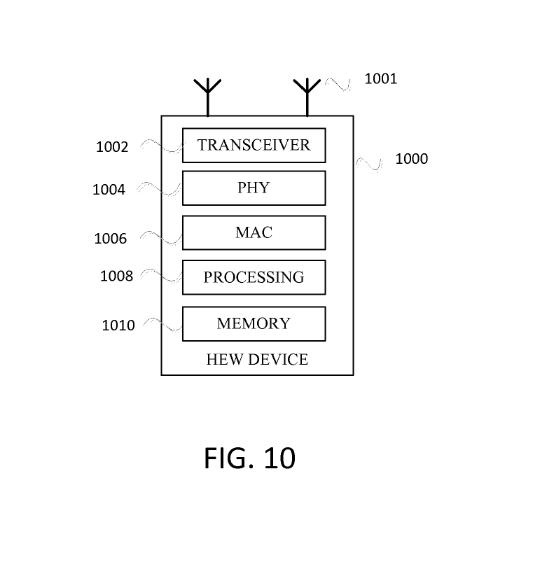

FIG. 10 illustrates a HEW device in accordance with some embodiments. HEW device 1000 may be an HEW compliant device that may be arranged to communicate with one or more other HEW devices, such as HEW devices 104 (FIG. 1) or access point 102 (FIG. 1) as well as communicate with legacy devices 106 (FIG. 1). HEW devices 104 and legacy devices 106 may also be referred to as HEW stations (STAs) and legacy STAs, respectively. HEW device 1000 may be suitable for operating as access point 102 (FIG. 1) or an HEW device 104 (FIG. 1). In accordance with embodiments, HEW device 1000 may include, among other things, a transmit/receive element 1001 (for example an antenna), a transceiver 1002, physical layer (PHY) circuitry 1004 and medium-access control layer circuitry (MAC) 1006. PHY 1004 and MAC 1006 may be HEW compliant layers and may also be compliant with one or more legacy IEEE 802.11 standards. MAC 1006 may be arranged to configure PPDUs and arranged to transmit and receive PPDUs, among other things. HEW device 1000 may also include other hardware processing circuitry 1008 and memory 1010 configured to perform the various operations described herein. The processing circuitry 1008 may be coupled to the transceiver 1002, which may be coupled to the transmit/receive element 1001. While FIG. 10 depicts the processing circuitry 1008 and the transceiver 1002 as separate components, the processing circuitry 1008 and the transceiver 1002 may be integrated together in an electronic package or chip.

In some embodiments, the MAC 1006 may be arranged to contend for a wireless medium during a contention period to receive control of the medium for the HEW control period and configure an HEW PPDU. In some embodiments, the MAC 1006 may be arranged to contend for the wireless medium based on channel contention settings, a transmitting power level, and a CCA level.

The PHY 1004 may be arranged to transmit the HEW PPDU. The PHY 1004 may include circuitry for modulation/demodulation, upconversion/downconversion, filtering, amplification, etc. In some embodiments, the hardware processing circuitry 1008 may include one or more processors. The hardware processing circuitry 1008 may be configured to perform functions based on instructions being stored in a RAM or ROM, or based on special purpose circuitry. In some embodiments, the hardware processing circuitry 1008 may be configured to perform one or more of the functions described herein in conjunction with FIGS. 1-9 such as fragmenting and aggregating MSDUs and/or MPDUs and using block acknowledgements.

In some embodiments, two or more antennas 1001 may be coupled to the PHY 1004 and arranged for sending and receiving signals including transmission of the HEW packets. The HEW device 1000 may include a transceiver to transmit and receive data such as HEW PPDU and packets that include an indication that the HEW device 1000 should adapt the channel contention settings according to settings included in the packet. The memory 1010 may store information for configuring the other circuitry to perform operations for configuring and transmitting HEW packets and performing the various operations described herein in conjunction with FIGS. 1-9.

In some embodiments, the HEW device 1000 may be configured to communicate using OFDM communication signals over a multicarrier communication channel. In some embodiments, HEW device 1000 may be configured to communicate in accordance with one or more specific communication standards, such as the Institute of Electrical and Electronics Engineers (IEEE) standards including IEEE 802.11-2012, 802.11n-2009, 802.11ac-2013, 802.11ax, DensiFi, standards and/or proposed specifications for WLANs, or other standards as described in conjunction with FIG. 1, although the scope of the invention is not limited in this respect as they may also be suitable to transmit and/or receive communications in accordance with other techniques and standards. In some embodiments, the HEW device 1000 may use 4× symbol duration of 802.11n or 802.11 ac.

In some embodiments, an HEW device 1000 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), an access point, a base station, a transmit/receive device for a wireless standard such as 802.11 or 802.16, or other device that may receive and/or transmit information wirelessly. In some embodiments, the mobile device may include one or more of a keyboard, a display, a non-volatile memory port, multiple antennas, a graphics processor, an application processor, speakers, and other mobile device elements. The display may be an LCD screen including a touch screen.

The antennas 1001 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result.

Although the device 1000 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The following examples pertain to further embodiments. Example 1 is a wireless communication device. The wireless communication device including circuitry configured to: fragment a media access control (MAC) service data unit (MSDU) into a plurality of MAC protocol data units (MPDU); set a sequence number field of each of the MPDUs of the plurality of MPDUs to indicate a relative position of each MPDU in a transmission stream of MPDUs, wherein the transmission stream of MPDUs includes the plurality of MPDUs; and set a position indication field of each of the MPDUs of the plurality of MPDUs to indicate a position of each MPDU in the plurality of MPDUs with respect to which portion of the MSDU the MPDU carries.

In Example 2, the subject matter of Example 1 can optionally include where the position indication field indicates whether each MPDU is a start MPDU, a middle MPDU, or a last MPDU of the plurality of MPDUs.

In Example 3, the subject matter of Example 1 can optionally include where the position indication field comprises two bits: a start MPDU field that indicates whether the MPDU is the start MPDU, and a last MPDU field that indicates whether the MPDU is the last MPDU.

In Example 4, the subject matter of Examples 1-3 can optionally include where the circuitry is further configured to: receive a schedule comprising an indication of a transmission time for the wireless communication device; and determine whether to fragment the MSDU based on the indication of the transmission time and a size of the MSDU.

In Example 5, the subject matter of Examples 1-4 can optionally include where the circuitry is further configured to: aggregate an MPDU with another MPDU into an aggregated MPDU.

In Example 6, the subject matter of Example 5 can optionally include where the circuitry is further configured to: receive a schedule comprising an indication of a transmission time for the wireless communication device; and determine whether to aggregate the MPDU with another MPDU based on the indication of the transmission time and a size of the MPDU and the another MPDU.

In Example 7, the subject matter of Examples 1-6 can optionally include where the circuitry is further configured to: receive a second plurality of MPDUs from a second wireless communication device; set a bit of a block acknowledgement corresponding to a sequence number of each of the second plurality of received MPDUs; and transmit the block acknowledgement to the second wireless communication device.

In Example 8, the subject matter of Examples 1-7 can optionally include of any of claims 1-7, where the circuitry is further configured to: receive a first schedule indicating a first transmission opportunity; send a first portion of the MPDUs of the plurality of MPDUs to a physical layer to be transmitted to a second wireless communication device in the first transmission opportunity; receive a second schedule indicating a second transmission opportunity; and send a second portion of the MPDUs of the plurality of MPDUs to the physical layer to be transmitted to the second wireless communication device in the second transmission opportunity.

In Example 9, the subject matter of Examples 1-8 can optionally include where the circuitry is further configured to: transmit each of the MPDUs of the plurality of MPDU to a second wireless communication device.

In Example 10, the subject matter of Examples 1-9 can optionally include where the circuitry is further configured to: receive a block acknowledgement comprising a plurality of bits from the second wireless communication device, wherein each bit of the block acknowledgment indicates whether a MPDU was received by the second wireless device; aggregate two or more MPDUs of the plurality of MPDUs that were not indicated to be received by the block acknowledgment; and transmit the aggregated MPDUs to the second wireless device.

In Example 11, the subject matter of Examples 1-10 can optionally include where the circuitry is further configured to: receive a second plurality of MPDUs from a second wireless communication device, wherein the second plurality of MPDUs are a fragmented second MSDU; and reconstruct the second MSDU from the second plurality of MPDUs, using the sequence number field of each of the second plurality of MPDUs and the position indication field of each of the second plurality of MPDUs.

In Example 12, the subject matter of Examples 1-11 can optionally include where the wireless communication device is configured to operate in accordance with 802.11ax.

In Example 13, the subject matter of Examples 1-12 can optionally further comprise memory and a transceiver coupled to the circuitry.

In Example 14, the subject matter of Example 13 can optionally further comprise one or more antennas coupled to the transceiver.

Example 15 is a method for fragmentation performed by a wireless communication device. The method includes fragmenting a media access control (MAC) service data unit (MSDU) into a plurality of MAC protocol data units (MPDU); setting a sequence number field of each of the MPDUs of the plurality of MPDUs to indicate a relative position of each MPDU in a transmission stream of MPDUs, wherein the transmission stream of MPDUs includes the plurality of MPDUs; and setting a position indication field of each of the MPDUs of the plurality of MPDUs to indicate a position of each MPDU in the plurality of MPDUs with respect to which portion of the MSDU the MPDU carries.

In Example 16, the subject matter of Examples 15 can optionally include where the position indication field indicates whether each MPDU is a start MPDU, a middle MPDU, or a last MPDU of the plurality of MPDUs.

In Example 17, the subject matter of Examples 15 can optionally include where the position indication field comprises two bits: a start MPDU field that indicates whether the MPDU is the start MPDU, and a last MPDU field that indicates whether the MPDU is the last MPDU.

In Example 18, the subject matter of Examples 15-17 can optionally include transmitting each of the MPDUs of the plurality of MPDU to a second wireless communication device.

In Example 19, the subject matter of Examples 15-18 can optionally include receiving a first schedule indicating a first transmission opportunity; sending a first portion of the MPDUs of the plurality of MPDUs to a physical layer to be transmitted to a second wireless communication device in the first transmission opportunity; receiving a second schedule indicating a second transmission opportunity; and sending a second portion of the MPDUs of the plurality of MPDUs to the physical layer to be transmitted to the second wireless communication device in the second transmission opportunity.

Example 20 is a high-efficiency wireless (HEW) device for fragmentation. The HEW device includes circuitry configured to: receive a schedule for a transmission opportunity; receive a plurality of media access control (MAC) service data units (MSDUs) to send to a second HEW device; aggregate two or more of the MSDUs into an aggregated MAC protocol data units (MPDU), wherein a size of the aggregated MPDU is determined by the schedule; and transmit the aggregated MPDU to the second HEW device.

In Example 21, the subject matter of Examples 15-18 can optionally include memory; a transceiver coupled to the processing circuitry; and one or more antennas coupled to the transceiver.

In Example 22, the subject matter of Examples 20 and 21 can optionally include where the circuitry is further configured to: fragment a first MSDU of the plurality of MSDU; aggregate a second MSDU of the plurality of MSDUs and one or more fragments of the first MSDU; and transmit the aggregated second MSDU and the one or more fragments of the first MSDU.

In Example 23, the subject matter of Examples 20-22 can optionally include where the circuitry is further configured to transmit the aggregated MPDU to the second HEW device in accordance with orthogonal frequency division multiple access during a transmission opportunity.

Example 24 is a non-transitory computer-readable storage medium that stores instructions for execution by one or more processors to perform operations for fragmentation on a wireless communication device. The operations to configure the wireless device to: fragment a media access control (MAC) service data unit (MSDU) into a plurality of MAC protocol data units (MPDU); set a sequence number field of each of the MPDUs of the plurality of MPDUs to indicate a relative position of each MPDU in a transmission stream of MPDUs, wherein the transmission stream of MPDUs includes the plurality of MPDUs; and set a position indication field of each of the MPDUs of the plurality of MPDUs to indicate a position of each MPDU in the plurality of MPDUs with respect to which portion of the MSDU the MPDU carries.

In Example 25, the subject matter of Example 24 can optionally include where the operations further comprise: transmitting each of the MPDUs of the plurality of MPDU to a second wireless communication device.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A wireless communication device, the wireless communication device comprising circuitry configured to:
fragment a media access control (MAC) service data unit (MSDU) into a plurality of MAC protocol data units (MPDU);
set a sequence number field of each of the MPDUs of the plurality of MPDUs to indicate a relative position of each MPDU in a transmission stream of MPDUs, wherein the transmission stream of MPDUs includes the plurality of MPDUs; and
set a position indication field of each of the MPDUs of the plurality of MPDUs to indicate a position of each MPDU in the plurality of MPDUs with respect to which portion of the MSDU the MPDU carries.

2. The wireless communication device of claim 1, wherein the position indication field indicates whether each MPDU is a start MPDU, a middle MPDU, or a last MPDU of the plurality of MPDUs.

3. The wireless communication device of claim 1, wherein the position indication field comprises two bits: a start MPDU field that indicates whether the MPDU is the start MPDU, and a last MPDU field that indicates whether the MPDU is the last MPDU.

4. The wireless communication device of claim 1, wherein the circuitry is further configured to:
receive a schedule comprising an indication of a transmission time for the wireless communication device; and
determine whether to fragment the MSDU based on the indication of the transmission time and a size of the MSDU.

5. The wireless communication device of claim 1, wherein the circuitry is further configured to:
aggregate an MPDU with another MPDU into an aggregated MPDU.

6. The wireless communication device of claim 5, wherein the circuitry is further configured to:
receive a schedule comprising an indication of a transmission time for the wireless communication device; and
determine whether to aggregate the MPDU with another MPDU based on the indication of the transmission time and a size of the MPDU and the another MPDU.

7. The wireless communication device of claim 1, wherein the circuitry is further configured to:
receive a second plurality of MPDUs from a second wireless communication device;
set a bit of a block acknowledgement corresponding to a sequence number of each of the second plurality of received MPDUs; and
transmit the block acknowledgement to the second wireless communication device.

8. The wireless communication device of claim 1, wherein the circuitry is further configured to:
receive a first schedule indicating a first transmission opportunity;
send a first portion of the MPDUs of the plurality of MPDUs to a physical layer to be transmitted to a second wireless communication device in the first transmission opportunity;
receive a second schedule indicating a second transmission opportunity; and
send a second portion of the MPDUs of the plurality of MPDUs to the physical layer to be transmitted to the second wireless communication device in the second transmission opportunity.

9. The wireless communication device of claim 1, wherein the circuitry is further configured to:
transmit each of the MPDUs of the plurality of MPDU to a second wireless communication device.

10. The wireless communication device of claim 1, wherein the circuitry is further configured to:
receive a block acknowledgement comprising a plurality of bits from the second wireless communication device, wherein each bit of the block acknowledgment indicates whether a MPDU was received by the second wireless device;
aggregate two or more MPDUs of the plurality of MPDUs that were not indicated to be received by the block acknowledgment; and
transmit the aggregated MPDUs to the second wireless device.

11. The wireless communication device of claim 1, wherein the circuitry is further configured to:
receive a second plurality of MPDUs from a second wireless communication device, wherein the second plurality of MPDUs are a fragmented second MSDU; and
reconstruct the second MSDU from the second plurality of MPDUs, using the sequence number field of each of the second plurality of MPDUs and the position indication field of each of the second plurality of MPDUs.

12. The wireless communication device of claim 1, wherein the wireless communication device is configured to operate in accordance with 802.11ax.

13. The wireless communication device of claim 1, further comprising memory and a transceiver coupled to the circuitry.

14. The wireless communication device of claim 13, further comprising one or more antennas coupled to the transceiver.

15. A method for fragmentation performed by a wireless communication device, the method comprising:
fragmenting a media access control (MAC) service data unit (MSDU) into a plurality of MAC protocol data units (MPDU);
setting a sequence number field of each of the MPDUs of the plurality of MPDUs to indicate a relative position of each MPDU in a transmission stream of MPDUs, wherein the transmission stream of MPDUs includes the plurality of MPDUs; and
setting a position indication field of each of the MPDUs of the plurality of MPDUs to indicate a position of each MPDU in the plurality of MPDUs with respect to which portion of the MSDU the MPDU carries.

16. The method of claim 15, wherein the position indication field indicates whether each MPDU is a start MPDU, a middle MPDU, or a last MPDU of the plurality of MPDUs.

17. The method of claim 15, wherein the position indication field comprises two bits: a start MPDU field that indicates whether the MPDU is the start MPDU, and a last MPDU field that indicates whether the MPDU is the last MPDU.

18. The method of claim 15, further comprising:
transmitting each of the MPDUs of the plurality of MPDU to a second wireless communication device.

19. The method of claim 15, further comprising:
receiving a first schedule indicating a first transmission opportunity;
sending a first portion of the MPDUs of the plurality of MPDUs to a physical layer to be transmitted to a second wireless communication device in the first transmission opportunity;
receiving a second schedule indicating a second transmission opportunity; and
sending a second portion of the MPDUs of the plurality of MPDUs to the physical layer to be transmitted to the second wireless communication device in the second transmission opportunity.

20. A high-efficiency wireless (HEW) device for fragmentation, the HEW device comprising circuitry configured to:
receive a schedule for a transmission opportunity;
receive a plurality of media access control (MAC) service data units (MSDUs) to send to a second HEW device;
aggregate two or more of the MSDUs into an aggregated MAC protocol data units (MPDU), wherein a size of the aggregated MPDU is determined by the schedule; and
transmit the aggregated MPDU to the second HEW device.

21. The HEW device of claim 20, further comprising memory; a transceiver coupled to the processing circuitry; and one or more antennas coupled to the transceiver.

22. The HEW device of claim 20, wherein the circuitry is further configured to:
fragment a first MSDU of the plurality of MSDU;
aggregate a second MSDU of the plurality of MSDUs and one or more fragments of the first MSDU; and
transmit the aggregated second MSDU and the one or more fragments of the first MSDU.

23. The HEW device of claim 20, wherein the circuitry is further configured to transmit the aggregated MPDU to the second HEW device in accordance with orthogonal frequency division multiple access during a transmission opportunity.

24. A non-transitory computer-readable storage medium that stores instructions for execution by one or more processors to perform operations for fragmentation on a wireless communication device, the operations to configure the wireless device to:
fragment a media access control (MAC) service data unit (MSDU) into a plurality of MAC protocol data units (MPDU);
set a sequence number field of each of the MPDUs of the plurality of MPDUs to indicate a relative position of each MPDU in a transmission stream of MPDUs, wherein the transmission stream of MPDUs includes the plurality of MPDUs; and
set a position indication field of each of the MPDUs of the plurality of MPDUs to indicate a position of each MPDU in the plurality of MPDUs with respect to which portion of the MSDU the MPDU carries.

25. The non-transitory computer-readable storage medium of claim 24, wherein the operations further comprise:
transmitting each of the MPDUs of the plurality of MPDU to a second wireless communication device.
